(19) United States
(12) Patent Application Publication
(10) Pub. No.: US 2016/0329149 A1
(43) Pub. Date: Nov. 10, 2016

(54) VARIABLE INDUCTOR AND VARIABLE INDUCTOR MODULE

(71) Applicant: Samsung Electro-Mechanics Co., Ltd., Suwon-si (KR)

(72) Inventors: Sung Jae YOON, Suwon-si (KR); Seong Jong CHEON, Suwon-si (KR)

(73) Assignee: Samsung Electro-Mechanics Co., Ltd., Suwon-si (KR)

(21) Appl. No.: 15/144,403

(22) Filed: May 2, 2016

(30) Foreign Application Priority Data
May 4, 2015 (KR) 10-2015-0062705

(51) Int. Cl. H01F 29/02

(52) U.S. Cl. CPC H01F 29/025

(57) ABSTRACT

A variable inductor includes: an inductor unit including an inductor pattern; a ground unit having a ground potential; and a space between the inductor pattern and the ground unit, the space being adjustable to vary an inductance value of the variable inductor.

### CROSS-REFERENCE TO RELATED APPLICATION(S)

This application claims the benefit under 35 USC 119(a) of Korean Patent Application No. 10-2015-0062705 filed on May 4, 2015 in the Korean Intellectual Property Office, the entire disclosure of which is incorporated herein by reference for all purposes.

### BACKGROUND

1. Field

The following description relates to a variable inductor in which inductance varies, and a variable inductor module.

2. Description of Related Art

Communications equipment such as mobile phone terminals employ semiconductor chip elements which implement circuits for radio frequency communications. When such chip elements are implemented, an inductor element is considered to be important. In particular, an inductor element having a high quality factor and inductance, while maintaining a reduced size, is required in the formation of a circuit for communications.

In general, in order for such an inductor element to be installed on a support board, stray capacity created between the inductor element and the support substrate is required be reduced. Also, when the inductor element is disposed to face wiring or an electrode on the support board, stray capacity may be created between the inductor element and the electric element. The stray capacity may degrade high frequency circuit characteristics, and thus, a reduction in the stray capacity may lead to an improvement of electrical characteristics of the inductor element.

An inductor element using a microelectromechanical system (MEMS) technique as disclosed in the related art has is commonly used in order to reducing stray capacity. However, the related art does not provide a technique for varying inductance by adjusting parasitic capacitance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a variable inductor includes: an inductor unit including an inductor pattern; a ground unit including a ground potential; and a space between the inductor pattern and the ground unit, the space being adjustable to vary an inductance value of the variable inductor.

The inductor unit may include: a pattern part including the inductor pattern; and an electrode part configured to receive external voltage.

The variable inductor may further include an insulating layer disposed between the pattern part and the ground unit.

The inductor unit may further include a path providing unit configured to prevent a short between an input line of the electrode part and the inductor pattern.

The electrode part and the pattern part may be positioned at a same height with respect to a surface of the variable inductor.

The electrode part and the ground unit may positioned at a same height with respect to a surface of the variable inductor, and the pattern part may be positioned higher than the ground unit.

The pattern part may be configured to bend, in response to the electrode part receiving the external voltage, to adjust the space.

The inductor unit and the ground unit may be configured through a microelectromechanical system (MEMS) technique.

The ground unit may be positioned below the inductor unit.

According to another general aspect, a variable inductor module includes: a variable inductor including an inductor unit including an inductor pattern, a ground unit having a ground potential, and a space between the inductor pattern and the ground unit; and a driver configured to apply voltage to the inductor unit and the ground unit to change the space to vary an inductance value of the variable inductor.

The driver may be configured to change a difference between voltages applied to the inductor unit and the ground unit, and to change the space by electrostatic force due to the difference between the voltages.

The inductor unit may include: a pattern part including the inductor pattern; and an electrode part connected to the pattern part and configured to receive the voltage from the driver.

The variable inductor module may further include an insulating layer disposed between the pattern part and the ground unit.

The inductor unit may further include a path providing unit configured to prevent a short between an input line of the electrode part and the inductor pattern.

The electrode part and the pattern part may be positioned at a same height with respect to a surface of the variable inductor.

The electrode part and the ground unit may be positioned at a same height with respect to a surface of the variable inductor, and the pattern part may be positioned higher than the ground unit.

The pattern part may be configured to bend, in response to the electrode part receiving the voltage from the driver, to change the space.

The inductor unit and the ground unit may be configured through a microelectromechanical system (MEMS) technique.

The ground unit may be positioned below the inductor unit.

Other features and aspects will be apparent from the following detailed description, the drawings, and the claims.

### BRIEF DESCRIPTION OF THE DRAWINGS

FIG. 1A is a perspective view illustrating a variable inductor, according to an embodiment.

FIG. 1B is a cross-sectional view of the variable inductor of FIG. 1A, taken along line a-a′ of FIG. 1A, according to an embodiment.

FIG. 2A is a perspective view illustrating a variable inductor according to another embodiment.

FIG. 2B is a cross-sectional view of the variable inductor of FIG. 2A, taken along line b-b′ of FIG. 2A, according to an embodiment.

FIG. 3A is an equivalent circuit diagram of a variable inductor, according to an embodiment.

FIG. 3B is a view illustrating a principle of varying inductance of a variable inductor, according to an embodiment.

FIGS. 4A and 4B are views schematically illustrating a configuration of a variable inductor module, according to an embodiment.

FIGS. 5A and 5B are top views of a variable inductor, according to another embodiment.

FIG. 6 is a graph illustrating varying of inductance of a variable inductor, according to an embodiment.

FIG. 7 is a table illustrating varying of inductance of a variable inductor, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the disclosed embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments will be described with reference to schematic views illustrating the embodiments. In the drawings, for example, due to manufacturing techniques and/or tolerances, modifications of the shape shown may be estimated. Thus, embodiments described herein should not be construed as being limited to the particular shapes of regions shown herein, for example, to include a change in shape results in manufacturing. The following embodiments may also be constituted by one or a combination thereof.

The contents described below may have a variety of configurations and propose only an example configuration herein, but are not limited thereto.

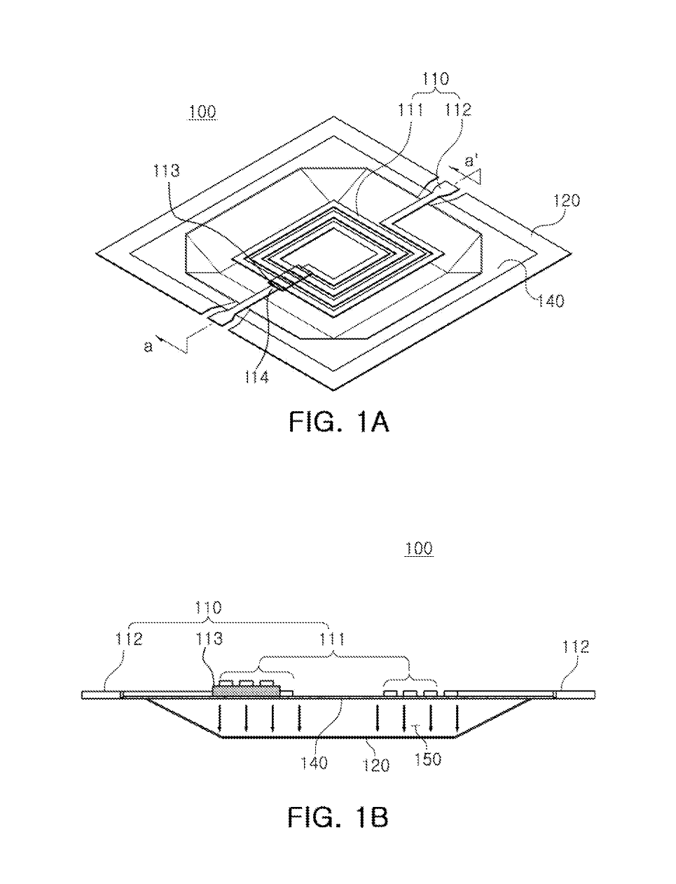

FIG. 1A is a perspective view illustrating a variable inductor 100, according to an embodiment. FIG. 1B is a cross-sectional view of the variable inductor 100 taken along line a-a′ of FIG. 1A, according to an embodiment. Referring to FIGS. 1A and 1B, the variable inductor 100 includes an inductor unit 110 and a ground unit 120 positioned on a lower surface of the inductor unit 110. The inductor unit 110 and the ground unit 120 may be configured through a microelectromechanical system (MEMS) technique. An air core 150 is disposed between the inductor unit 110 and the ground unit 120. Additionally, an insulating layer 140 is positioned between the inductor unit 110 and the ground unit 120.

The inductor unit 110 includes a pattern part 111 having an inductor pattern and an electrode part 112 provided at opposing ends of the pattern part 111. The electrode part 112 and the pattern part 111 may be positioned at the same height on one surface of the variable inductor 100. The pattern part 111 is illustrated to include a spiral inductor pattern, but is not limited thereto. Further, the inductor pattern may have various shapes such as a meander line, or the like.

The inductor unit 110 further includes a path providing unit 113 that is configured to prevent a short between an input line 114 of the electrode part 112 and the inductor pattern of the pattern part 111.

When voltage is applied to the electrode part 112, the pattern part 111 may bend toward the ground unit 120, and accordingly, a space (i.e., an interval or a distance) between the pattern part 111 and the ground unit 120 may be reduced, and an inductance value of the variable inductor 100 may vary according to the reduced space. In detail, the inductance value may be lowered in comparison to a case before the voltage is applied to the electrode part 112.

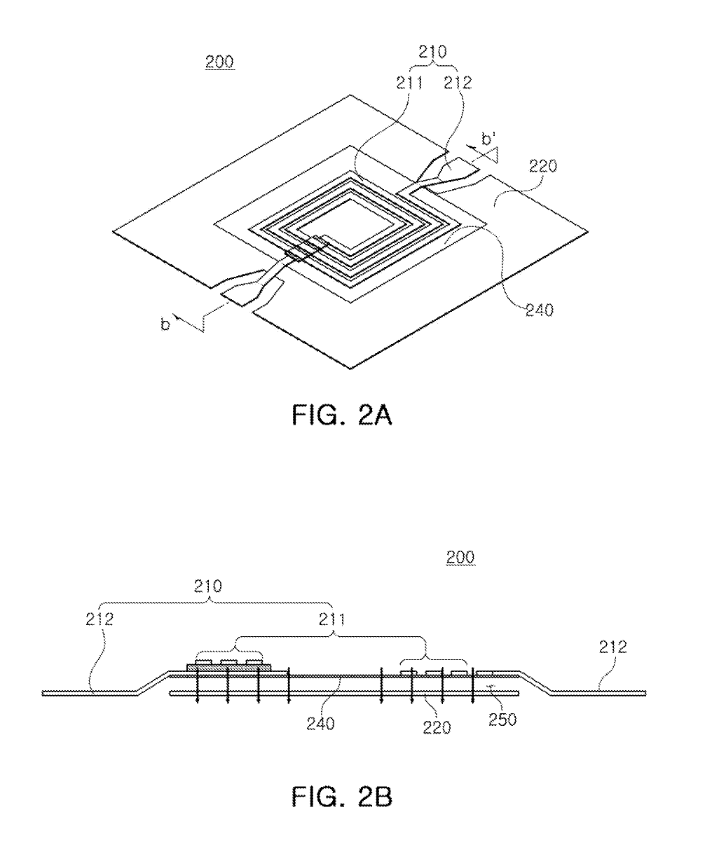

FIG. 2A is a perspective view illustrating a variable inductor 200, according to another embodiment. FIG. 2B is a cross-sectional view of the variable inductor 200 taken along line b-b′ of FIG. 2A, according to an embodiment. The variable inductor 200 generally includes the same components as those of the variable inductor 100 of FIGS. 1A and 1B, except for the configuration of a pattern part 211 and an electrode part 212.

The variable inductor 200 includes an inductor unit 210 and a ground unit 220 positioned below the inductor unit 210. An air core 250 is disposed between the inductor unit 210 and the ground unit 220. Additionally, an insulating layer 240 is positioned between the inductor unit 210 and the ground unit 220.

The inductor unit 210 includes the pattern part 211 having an inductor pattern and the electrode part 212 provided at opposing ends of the pattern part 211. The electrode part 212 and the ground unit 220 may be positioned at the same height with respect to one surface of the variable inductor 200, and the pattern part 211 may be positioned higher than the ground unit 220.

Similarly to the above description with respect to the variable inductor 100 of FIGS. 1A and 1B, the pattern part 211 may bend toward the ground unit 220 as indicated by the arrows illustrated in FIG. 2B. Accordingly, a space between the pattern part 211 and the ground unit 220 may be reduced and an inductance value of the variable inductor 200 may be lowered according to the reduced space.

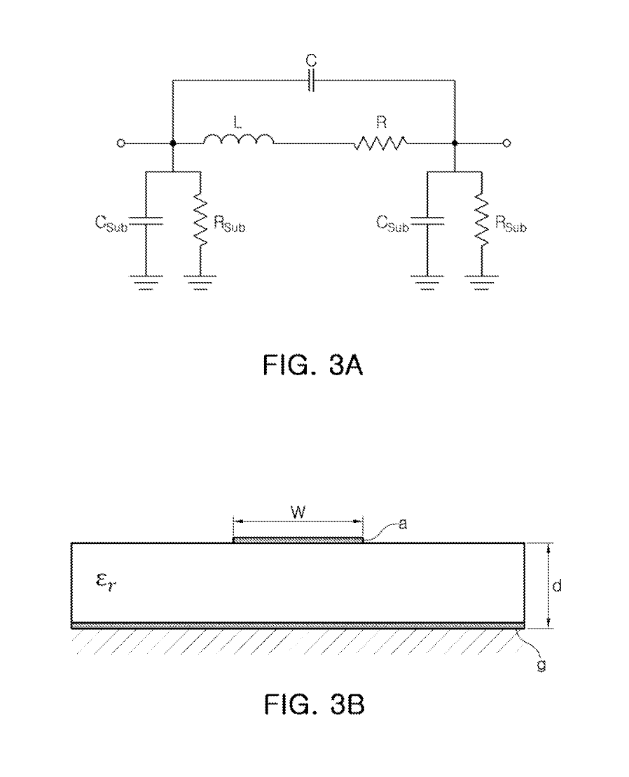

FIG. 3A is an equivalent circuit diagram of a variable inductor (e.g., the variable inductor 100/200 described above), according to an embodiment. FIG. 3B is a view illustrating a principle of varying inductance of a variable inductor, according to an embodiment.

Referring to FIG. 3A, the variable inductor has inductance L, capacitance C, and resistance R.

In addition, since the ground unit (e.g., the ground unit 120/220 described above) is positioned on a lower surface of the pattern part (e.g., the above-described pattern part 111/211), the variable inductor has parasitic capacitance C_{sub} and parasitic resistance R_{sub}. As a space between the pattern part and the ground unit is varied, the parasitic capacitance C_{sub} varies.

In detail, as the space between the pattern part and the ground unit is reduced, the parasitic capacitance C_{sub} increases, and accordingly, inductance of the variable inductor lowers.

An actual inductor, rather than an ideal inductor, has a self-resonance frequency, and a component enabling the inductor to have the self-resonance frequency is parasitic capacitance of the inductor.

The self-resonance frequency may be expressed by Equation 1 below.

$${f}_{res} = \frac{1}{ω \sqrt{{LC}_{sub}}} \qquad [ Equation 1 ]$$

In Equation 1, fᵣₑₛ denotes a self-resonance frequency, and C_{sub} denotes parasitic capacitance. Referring to Equation 1, as the parasitic capacitance increases, the self-resonance frequency lowers, and inductance of the inductor is reduced toward the self-resonance frequency. Accordingly, as parasitic capacitance increases, inductance in the same frequency band decreases.

The aforementioned reduction in inductance will be described with reference to FIG. 3B.

FIG. 3B is a view illustrating a principle of varying inductance of a variable inductor, according to an embodiment. Referring to FIG. 3B, in a case in which an inductor is configured as a transmission line (“transmission inductor”; refer to reference letter “a”), inductance of the transmission inductor may be expressed by Equation 2 below.

$${L}_{T} = \frac{{Z}_{0}}{2 π f} sin ( \frac{2 π l}{{λ}_{g}} ) \qquad [ Equation 2 ]$$

In Equation 2, Lᵣ denotes inductance of the transmission inductor, Zₒ denotes characteristic impedance, λ_{g} denotes a wavelength, and l denotes a length of the transmission inductor.

A transmission line equation (in the case of a microstrip) of Z₀ may expressed by Equation 3.

$${Z}_{0} = \frac{120 π}{\sqrt{{ɛ}_{e}} [ \frac{w}{d} + 1.393 + 0.667 ln ( \frac{w}{d} + 1.444 ) ]} \qquad [ Equation 3 ]$$

As illustrated in FIG. 3B, W denotes a width of the transmission inductor, d denotes a distance between the transmission inductor and a ground (refer to reference letter “g”), and ∈ₑ refers to an effective dielectric constant.

In the case of the microstrip line, ∈ₑ may be expressed by Equation 4 according to a relation equation between permeability (∈ᵣ) illustrated in FIG. 3B and air permeability (∈ᵣ≈1).

$${ɛ}_{e} = \frac{{ɛ}_{r} + 1}{2} + \frac{{ɛ}_{r} - 1}{2} \frac{1}{\sqrt{1 + \frac{12 d}{w}}} \qquad [ Equation 4 ]$$

Based on Equation 2 to Equation 4 described above, as the distance d is reduced, impedance Zₒ is decreased, and accordingly, impedance L_{T} is also decreased.

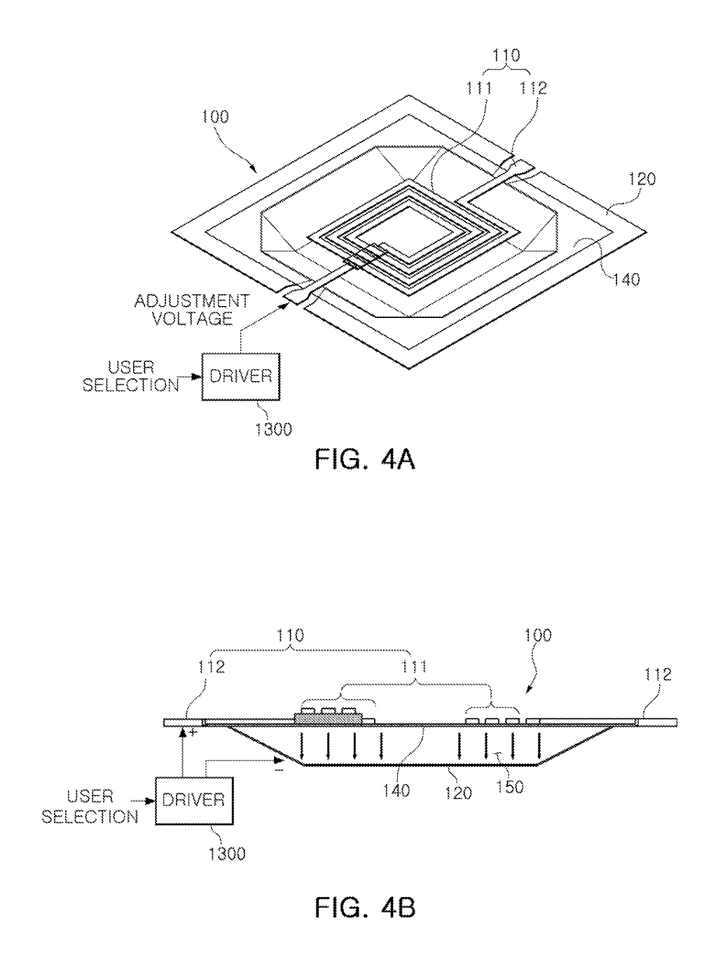

FIGS. 4A and 4B are views schematically illustrating a configuration of a variable inductor module 1000, according to an embodiment. Referring to FIGS. 4A and 4B, the variable inductor module 1000 includes a driver 1300 and the variable inductor 100 of FIGS. 1A and 1B. The driver 1300 is electrically connected to the variable inductor 100 and applies an adjustment voltage to the variable inductor 100 according to a user selection. The electrode part 112 of the inductor unit 110 receives the adjustment voltage from the driver 1300.

In detail, the adjustment voltage from the driver 1300 may be a direct current (DC) voltage. A positive (+) voltage may be applied to the electrode part 112 and a negative (−) voltage may be applied to a ground unit 120. A space between the pattern part 111 of the inductor unit 110 and the ground unit 120 may be reduced as the pattern part 111 is bent toward the ground unit 120 by electrostatic force due to a difference between voltages applied to the electrode part 112 and the ground unit 120, and, accordingly, parasitic capacitance may be increased to lower inductance.

The electrostatic force may be expressed by Equation 5 below.

$$F = \frac{ɛ \cdot {SV}^{2}}{2 {d}^{2}} \qquad [ Equation 5 ]$$

In Equation 5, ∈ denotes permeability, V denotes a voltage difference, S denotes an area, and d denotes an interval.

As illustrated in FIGS. 4A and 4B, the electrode part 112 and the pattern part 111 may be positioned at the same height with respect to one surface of the variable inductor 100.

Also, in a case in which the variable inductor module 1000 is employed in an RF device, an RF signal may also be applied to the electrode part 112 provided at both ends of the pattern part 111.

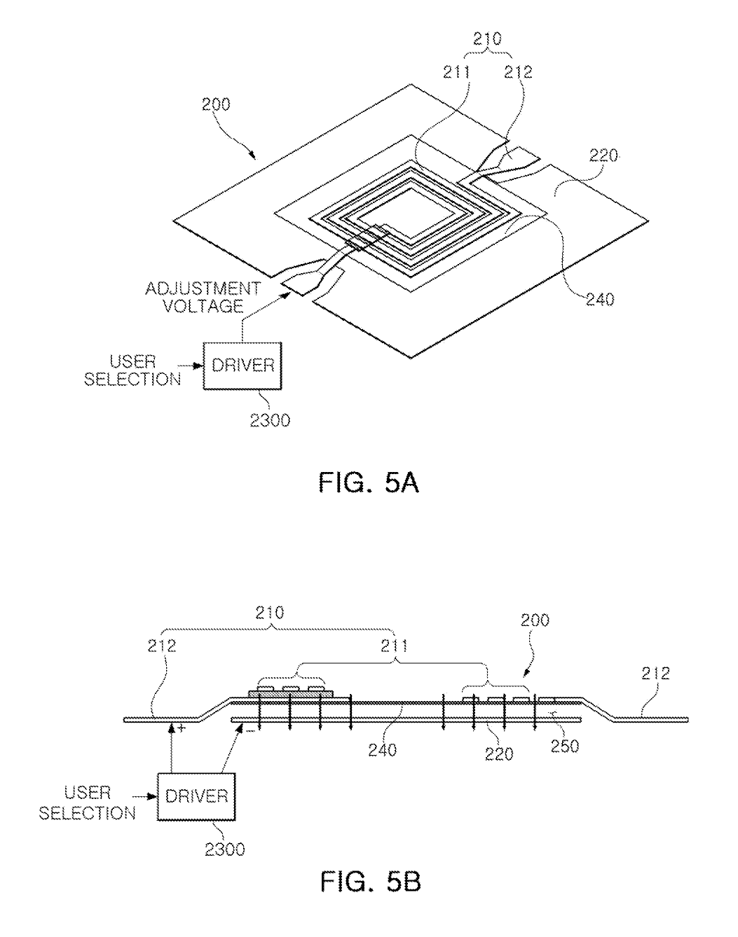

FIGS. 5A and 5B are top views of a variable inductor module 2000, according to another embodiment. Referring to FIGS. 5A and 5B, the variable inductor module 2000 includes a driver 2300 in addition to the variable inductor 200 of FIGS. 2A and 2B.

Similarly to the driver 1300 in FIGS. 4A and 4B, the driver 2300 applies an adjustment voltage to the variable inductor 200. The adjustment voltage from the driver 2300 may be a DC voltage. A positive (+) voltage may be applied to the electrode part 212 and a negative (−) voltage may be applied to a ground unit 220. A space between the pattern part 211 of the inductor unit 210 and the ground unit 220 may be reduced as the pattern part 211 is bent toward the ground unit 220 by electrostatic force due to a difference between voltages applied to the electrode part 212 and the ground unit 220, and, accordingly, parasitic capacitance may be increased to lower inductance.

As illustrated in FIGS. 5A and 5B, the electrode part 212 and the ground unit 220 may be positioned at the same height with respect to one surface of the variable inductor 200, and the pattern part 211 may be positioned above the ground unit 220.

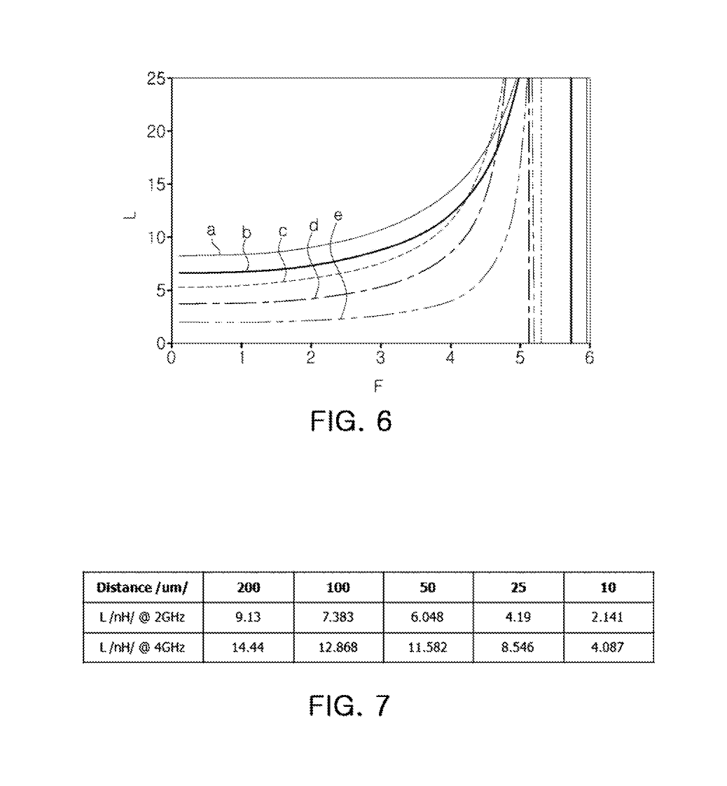

FIG. 6 is a graph illustrating varying of inductance of a variable inductor according to an embodiment. FIG. 7 is a table illustrating varying of inductance of a variable inductor, according to an embodiment.

Referring to FIGS. 6 and 7, it can be seen that inductance of a variable inductor varies according to spaces (distances) between a pattern part and a ground unit. That is, in the graph illustrated in FIG. 6, reference letters a, b, c, d and e denote various spaces between the pattern part and the ground unit as 200 um, 100 um, 50 um, 25 um, and 10 um, respectively. As illustrated in the graph and the table of FIG. 7, in a case in which the spaces (distances) between the pattern part and the ground unit are 200 um, 100 um, 50 um, 25 um, and 10 um, inductance is 9.13 nH, 7.383 nH, 6.048 nH, 4.19 nH, and 2.141 nH at a 2 GHz band, respectively, and 14.44 nH, 12.868 nH, 11.582 nH, 8.546 nH, and 4.087 nH at a 4 GHz band, respectively, it can be seen that inductance lowers as the size of the space between the pattern part and the ground unit is reduced.

As described above, according to an embodiment, inductance may be varied while a high Q value is maintained and inductance may be varied even in a limited space.

As set forth above, according to embodiments disclosed herein, inductance of a variable inductor may be varied while high quality factor is maintained.

The apparatuses, units, modules, devices, and other components (e.g., the drivers 1300 and 2300) illustrated in FIGS. 4A, 4B, 5A and 5B that perform the operations described herein with are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A variable inductor comprising:
an inductor unit comprising an inductor pattern;
a ground unit comprising a ground potential; and
a space between the inductor pattern and the ground unit, the space being adjustable to vary an inductance value of the variable inductor.

2. The variable inductor of claim 1, wherein the inductor unit comprises:
a pattern part comprising the inductor pattern; and
an electrode part configured to receive external voltage.

3. The variable inductor of claim 2, further comprising an insulating layer disposed between the pattern part and the ground unit.

4. The variable inductor of claim 2, wherein the inductor unit further comprises a path providing unit configured to prevent a short between an input line of the electrode part and the inductor pattern.

5. The variable inductor of claim 2, wherein the electrode part and the pattern part are positioned at a same height with respect to a surface of the variable inductor.

6. The variable inductor of claim 2, wherein the electrode part and the ground unit are positioned at a same height with respect to a surface of the variable inductor, and the pattern part is positioned higher than the ground unit.

7. The variable inductor of claim 2, wherein the pattern part is configured to bend, in response to the electrode part receiving the external voltage, to adjust the space.

8. The variable inductor of claim 1, wherein the inductor unit and the ground unit are configured through a microelectromechanical system (MEMS) technique.

9. The variable inductor of claim 1, wherein the ground unit is positioned below the inductor unit.

10. A variable inductor module comprising:
a variable inductor comprising
an inductor unit comprising an inductor pattern,
a ground unit comprising a ground potential, and
a space between the inductor pattern and the ground unit; and
a driver configured to apply voltage to the inductor unit and the ground unit to change the space to vary an inductance value of the variable inductor.

11. The variable inductor module of claim 10, wherein the driver is configured to change a difference between voltages applied to the inductor unit and the ground unit, and to change the space by electrostatic force due to the difference between the voltages.

12. The variable inductor module of claim 10, wherein the inductor unit comprises:
a pattern part comprising the inductor pattern; and
an electrode part connected to the pattern part and configured to receive the voltage from the driver.

13. The variable inductor module of claim 12, further comprising an insulating layer disposed between the pattern part and the ground unit.

14. The variable inductor module of claim 12, wherein the inductor unit further comprises a path providing unit configured to prevent a short between an input line of the electrode part and the inductor pattern.

15. The variable inductor module of claim 12, wherein the electrode part and the pattern part are positioned at a same height with respect to a surface of the variable inductor.

16. The variable inductor module of claim 12, wherein the electrode part and the ground unit are positioned at a same height with respect to a surface of the variable inductor, and the pattern part is positioned higher than the ground unit.

17. The variable inductor module of claim 12, wherein the pattern part is configured to bend, in response to the electrode part receiving the voltage from the driver, to change the space.

18. The variable inductor module of claim 10, wherein the inductor unit and the ground unit are configured through a microelectromechanical system (MEMS) technique.

19. The variable inductor module of claim 10, wherein the ground unit is positioned below the inductor unit.
